(19) United States
(12) Patent Application Publication
(10) Pub. No.: US 2006/0018125 A1
(43) Pub. Date: Jan. 26, 2006

(54) High-efficiency fiber optic lighting system

(76) Inventors: Jack V. Miller, Seaford, DE (US); Ruth Ellen Miller, Seaford, DE (US)

Correspondence Address: Jack V. Miller, 20915 Sussex Highway, Seaford, DE, 19973, US

(21) Appl. No.: 10/897,224

(22) Filed: Jul. 21, 2004

(51) Int. Cl. F21V 7/04

(52) U.S. Cl. 362/554; 362/556; 362/294; 362/558; 362/230; 362/231; 362/345; 362/296; 362/298; 362/302

(57) ABSTRACT

This application provides a fiber optic system including a projector of improved efficiency with a light source on an optical axis at the primary focus of an ellipsoidal reflector. The ellipsoidal reflector focuses visible light from the light source to a conjugate focus through a dichroic hot mirror and into a glass rod disposed between the conjugate focus and a fiber optic light guide. A confocal reflector has a spherical radius about the light source, said radius being equal to the distance from the primary focus to the conjugate focus. The proximal end of the glass rod is positioned on the optical axis in a hole through the confocal reflector at the conjugate focus, whereby rays from the light source that fall outside the hole in the reflector are reflected by the spherical confocal reflector back to the light source to be re-reflected as additional light focused onto the conjugate focus and through the glass rod to one or more fiber optic light guides. The foregoing optical components are enclosed in a housing having heat flow paths to the housing exterior.

### BACKGROUND OF THE INVENTION

The present invention relates to the field of fiber optic lighting systems, and more particularly to projectors for focussing light into and through a fiber optic light guide having a single proximal end and a multiple tail distal end.

The first goal of a fiber optic projector is to focus uniform light into the proximal end of the light guide. The Uniform light pattern into the proximal light guide end is necessary or the output intensity of the distal ends will vary from tail to tail. Thus the focussed beam uniformity is of critical importance.

The second goal of a fiber optic projector is to focus very intense light into the proximal end of the light guide without melting or burning the optical fibers. However all light sources, both tungsten-halogen and metal halide lamps, emit far more heat energy than visible illumination. Over 90% of the output of a tungsten-halogen lamp and 60% of the output of a metal halide arc lamp are IR (infrared) energy. Plastic fibers thus are easily “caramelized”. Glass fibers themselves are very heat resistant, but the fine, hair-like fibers must be bonded together with epoxy at the proximal end in order to polish the end so it will accept light. The epoxy bonding is known to absorb heat, visible light and UV, so it darkens, absorbs more energy, decomposes into powdery ash, and the proximal end literally falls apart.

Because of proximal end fiber failures, most fiber optic equipment manufacturers attempt to protect the fiber ends in the projector from excess heat by two means. The first is a the use of a light source having a glass ellipsoidal reflector that has a light-reflecting, infrared-transmitting, dichroic coating called a “cold mirror”. The second means is an IR reflecting “hot mirror” in front of the heat-sensitive proximal end of the light guide. However, both cold mirrors and hot mirrors are only about 60% efficient in separating heat from light. As a result, the manufacturers of these prior art systems warrant their fiber optic light guides for only one year. Also they recommend leaving a five-foot-long service loop at the projector, so the proximal end can be periodically cut off when the plastics become yellowed, melted and scorched. Then the fresh fiber ends are smoothed by polishing or cutting with a hot knife and re-inserted into the projector.

### SUMMARY OF THE INVENTION

The present invention is a fiber optic projector of improved efficiency with a light source at the proximal end of an optical axis at the primary focus of an ellipsoidal reflector. The ellipsoidal reflector focuses visible light emitted by the light source through a dichroic hot mirror to a conjugate focus in the distal direction on the optical axis. A glass rod is disposed between the conjugate focus and a fiber optic light guide. A confocal reflector has a spherical radius about the light source, with the radius equal to the distance from the primary focus to the conjugate focus. The glass rod is positioned on the optical axis in a hole through the confocal reflector at the conjugate focus. The optical components are then enclosed in a housing having an exit aperture therethrough on the optical axis. The proximal end of the light guide is held on the optical axis in the exit aperture. In a second preferred embodiment the ellipsoidal reflector and confocal reflector are integral with the housing, and in a third preferred embodiment air passages are provided to facilitate air cooling.

### BRIEF DESCRIPTION OF THE DRAWINGS

Prior art FIG. 1 is a simplified optical diagram of a longitudinal cross-section of a prior art fiber optic system using an ellipsoidal reflector focussing light in the proximal end of a fiber optic light guide through an infrared filter as shown in FIG. 1.

Prior art FIG. 2 is a simplified optical diagram of a longitudinal cross-section of a fiber optic system according the applicants' U.S. Pat. No. 5,099,399.

Prior art FIG. 3 is a simplified optical diagram of a longitudinal cross-section showing the wasted light in prior art fiber optic systems.

FIG. 4 is a longitudinal cross-section showing a first preferred embodiment of the present invention.

FIG. 5 is a longitudinal cross-section showing a second preferred embodiment of the present invention including radiation cooling.

FIG. 6 is a longitudinal cross-section showing a third preferred embodiment of the present invention including cooling air passages.

Prior art FIG. 7 is a longitudinal cross-section showing a prior art light fixture of U.S. Pat. No. 5,695,227, which uses an ellipsoidal reflector, a spherical confocal reflector on an optical axis and also using a third reflector that is a male spherical reflector; and

Prior art FIG. 8 is a longitudinal cross-section of a prior art light fixture according to U.S. Pat. No. 6,161,946, using a spherical mirror, which is not confocal with the light source on the optical axis.

### DESCRIPTION OF PRIOR ART

In the following descriptions of prior art, numbers are assigned to elements having functions similar to elements performing a like function in the present invention. For instance, lamp 1 of the present invention would also be lamp 1 in each prior art reference.

Prior art FIG. 1 is an example of a prior art fiber optic projector is shown in a simplified optical diagram. A lamp 1 (Prior art FIG. 1, element 1) is shown on an optical axis 2 emitting both heat and light from a light source 3 which is the primary focus of a dichroic “cold mirror” ellipsoidal reflector 4. Reflector 4 reflects most of the visible light to a conjugate focus 5. Some of the infrared radiation 8 from the light is radiated outwards, and the remaining IR (infrared) is focussed at conjugate focus 5 at a dichroic “hot mirror” 6 where a portion of the IR is reflected back towards lamp 1 and reflector 4. Dichroic hot mirror 6 is spaced a distance from the proximal end of a light guide 12, comprised of either single or multiple fibers of either plastic or plastic-bonded glass fibers. The axial spacing between hot mirror 6 and light guide 7 is to allow the very intense beam at conjugate focus 5 to expand to the diameter of light guide 12, making the center of the beam less intense for more uniform light across the light guide and spreading some damaging heat outward from the beam center on the optical axis. The foregoing techniques are not very effective, and thermal damage to the light guides occurs in a relatively short time. As a result, light guides are usually warranted for only one year, and then the warranty is often pro-rated. This general configuration, as shown in U.S. Pat. No. 4,025,779, is presently manufactured by at least a dozen manufacturers.

Prior art FIG. 2. At the present time the only fiber optic projectors with no UV or IR to damage optical fibers systems use the applicants' U.S. Pat. No. 5,099,399. Those projectors do not “caramelize” (age, melt or burn) fiber ends, so the light guides are warranted for 10 years. A simplified optical diagram of the '399 patent is shown in Prior art FIG. 2, in which an elongated glass rod 7 is placed between the hot mirror 5 and fiber optic light guide 12. Glass rod 7 receives, homogenizes and transmits the visible light to the light guide 12 at the distal end 9 of glass rod 7. Thus the light received by the fibers of light guide 12 is perfectly homogenized and uniform, whereby all fibers are equally bright. A dichroic hot mirror 6 may be optionally placed at conjugate focus 5, although it can be located anywhere between reflector 4 and glass rod 7. Many of such fiber optic systems have been made, sold and remained in service for more that ten years without fiber damage.

The elongated glass rod 7 has the characteristic of absorbing, transversely conducting and emitting IR (infrared), and incidentally absorbing the UV (ultraviolet) energy from the light along its length, so the fibers of light guide 12 are not damaged. Thus the '399 system meets the requirement for “no UV and no IR” in museum, retail merchandise, and even food lighting, as specified in the Handbook of the I.E.S.N.A. (Illuminating Engineering Society of North America) pages 587, 586 and 166.

Prior art FIG. 3 optical diagram is applicable to prior art fiber optic systems of either FIG. 1 or FIG. 2. As illustrated, there are known optical losses evident in the '399 patent The losses are within a hollow cone of revolution emanating from the primary focus 0 of light source 3, through angles A-O-C and A′-O-C′, that comprises the light from the light source 3 that is not captured by reflector 4. That lost light amounts to approximately 40% of the light captured by the reflector. If that wasted light can be captured and focussed into light guide 12, the light output of the system is increased by 40%. However, image magnification and surface reflection losses will reduce the gain to about 25%, still a significant increase in optical efficiency.

### DETAILED DESCRIPTION OF THE PREFERRED EMBODIMENTS

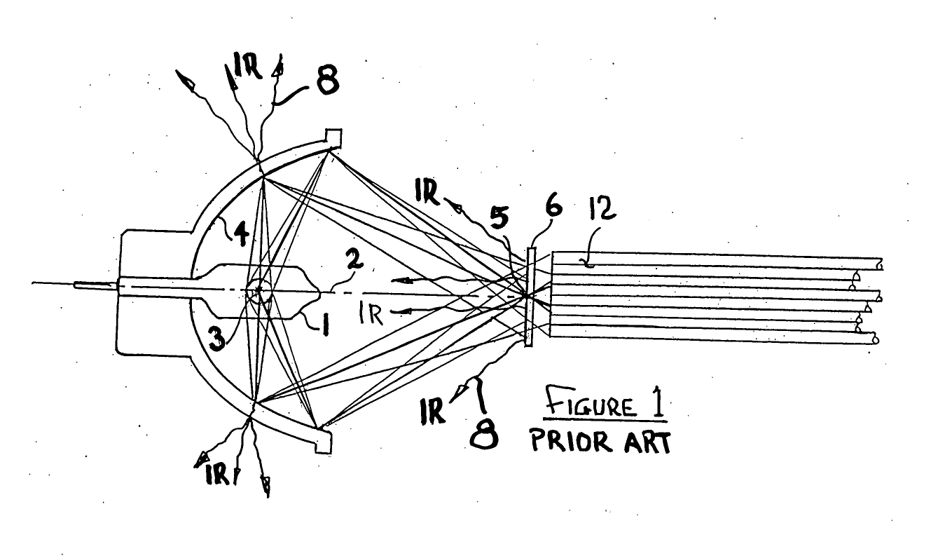

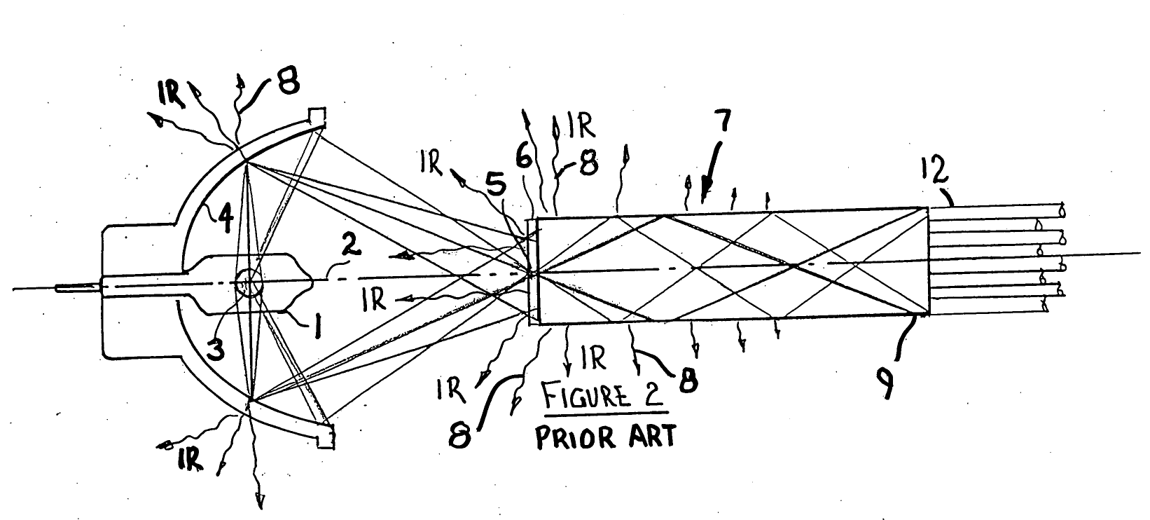

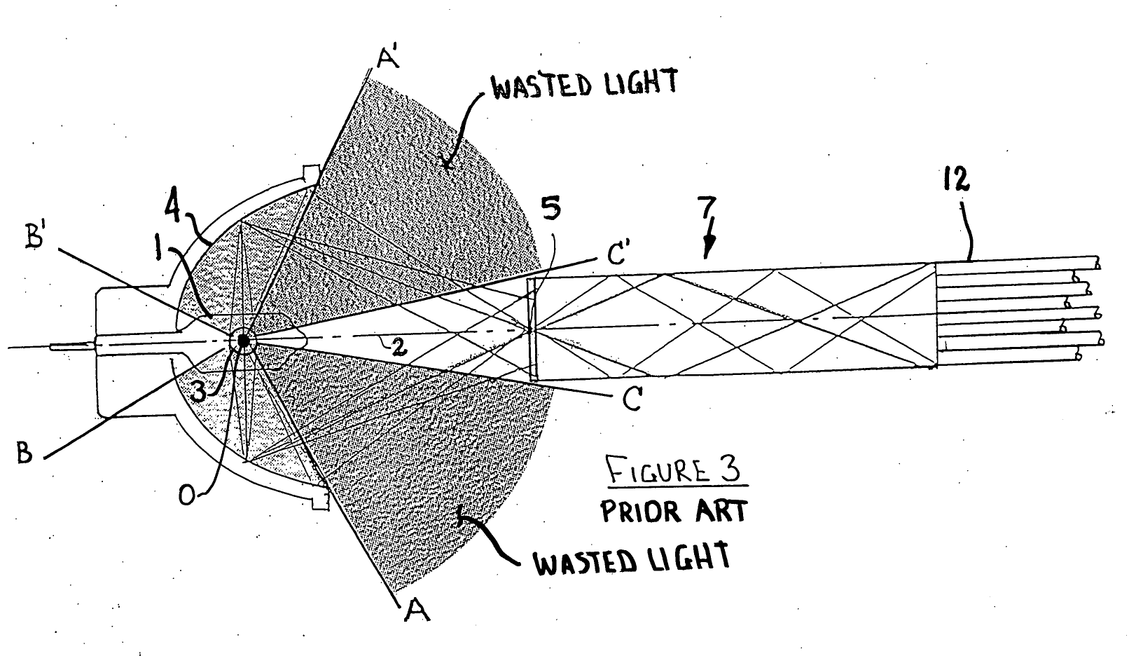

FIG. 4 shows a longitudinal cross-section view of a preferred embodiment of a fiber optic system according to the present invention. As in the applicants' '399 patent, this embodiment has a light source 1 at the proximal end of an optical axis 2 at the primary focus 3 of an ellipsoidal reflector 4. Reflector 4 may be a dichroic reflector that transmits a most of the lamp IR and some visible light. Reflector 4 focuses a portion of the IR, UV and visible light from light source 3 to conjugate focus 5 on optical axis 2.

A glass rod 7 is placed with its proximal end at conjugate focus 5 to absorb the UV and IR and transmit only the visible light to the light guide 12 at the distal end 9 of optical axis 2. As in FIG. 3 from the applicants' '399 patent, glass rod 7 A dichroic hot mirror 6 also may be optionally placed at conjugate focus 5 as in the '399 patent in FIG. 2. However, a preferable optional location for dichroic hot mirror 6 is at the rim of reflector 4 as shown in FIG. 4. Experience has shown that intense focussed light photons will bombard and literally wear out a hot mirror in continued use for several years. The larger hot mirror at the reflector rim distributes the light energy over an area over 5 times greater than that of a cross-sectional area of the glass rod, and thus larger hot mirror 6 at the reflector rim will provide a service life more than 5 times longer.

In order to utilize the wasted light in the cone of revolution subtended by angles AOC and A′OC′ in FIG. 3, the embodiment of the present invention shown in FIG. 4 includes a confocal reflector 10 having a spherical radius R about light source 3 on the proximal end of an optical axis 2. The spherical radius is tangent to the plane of conjugate focus 5. Confocal reflector 10 has a hole 11 on optical axis 2 in which the proximal end of glass rod 8 is located. Thus direct-emitted rays DE will travel in the distal direction through hot mirror 6, through hole 11 in confocal reflector 10, and into and through glass rod 7 at the sharpest, most efficient focal point. As in FIG. 2, glass rod 7 receives, homogenizes and transmits the visible light to the light guide 12 at the distal end 9 of glass rod 7. Thus the light received by the fibers of light guide 12 is perfectly uniform, whereby all fibers are equally bright.

Further, direct rays DR from light source 3 striking confocal reflector 10 will be back reflected as rays RR to the principal focus at light source 3, which may be an incandescent filament or an arc gap. Rays shown as RR rays striking the light source 3 can absorbed and re-radiated by light source 3. Rays RR that pass through or near light source 3 are then re-reflected from reflector 4 and travel through hot mirror 6 to conjugate focus 5 as additional light energy. Those rays pass through hole 11 in confocal reflector 10 and through glass rod 7 to its distal end 9 to illuminate light guide 12. Glass rod 7 is in inintimate thermal contact with heat radiator 14. Housing 13 and heat radiator 14 enclose, cool the internal optical parts and light guide 12.

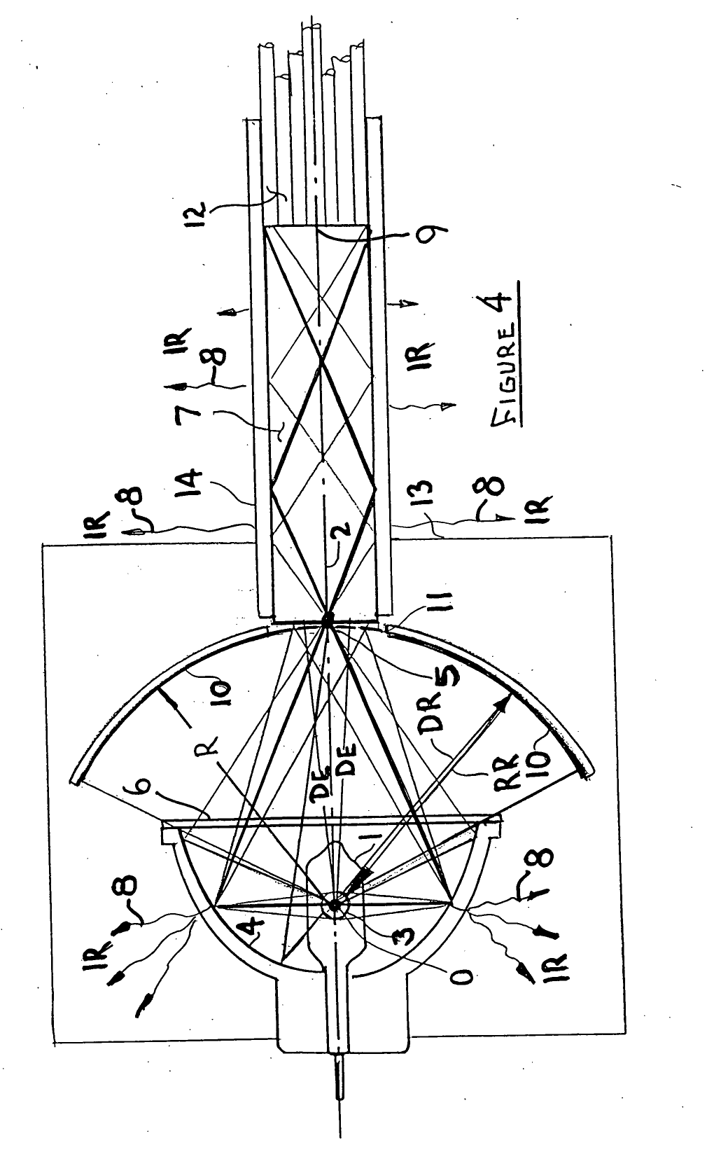

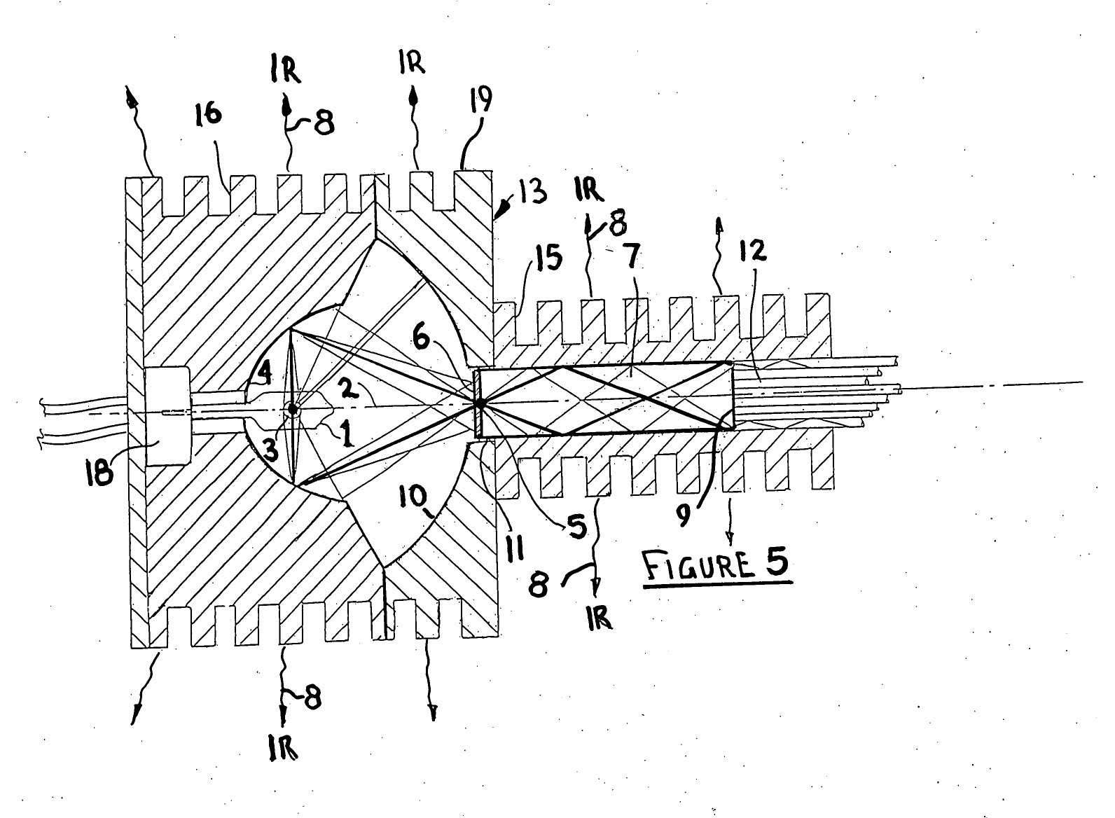

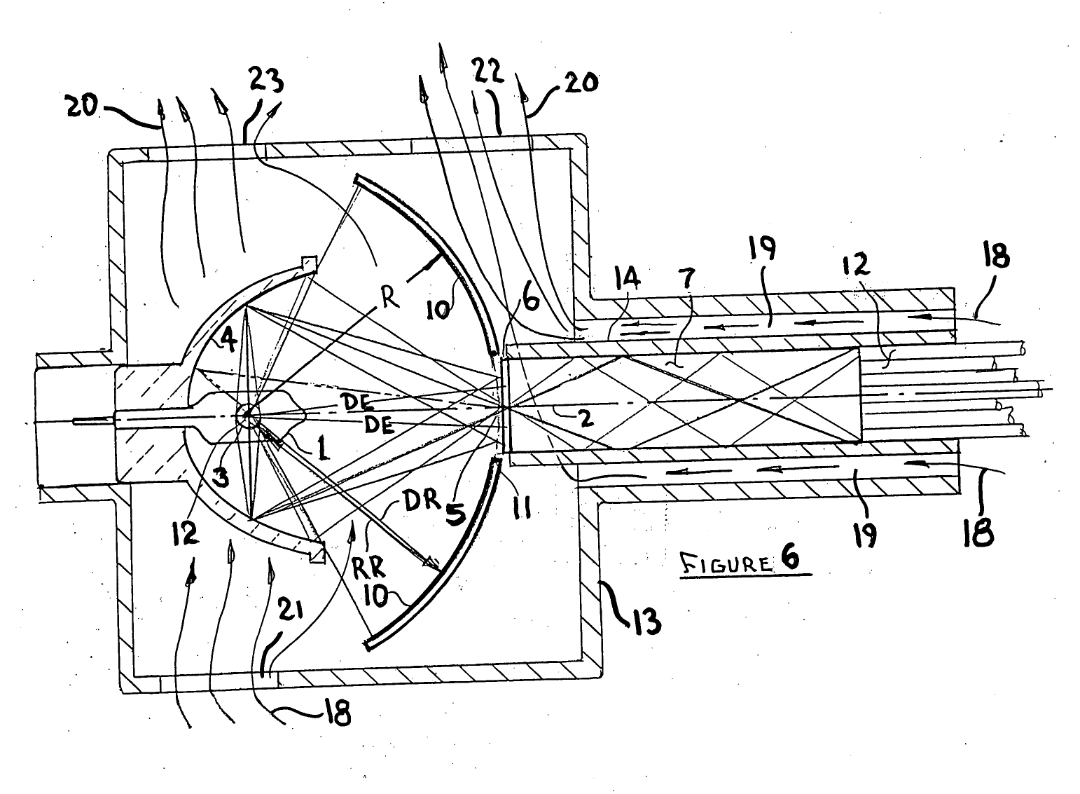

FIG. 5 is a longitudinal cross-section view of a second preferred embodiment according to the present invention. The second preferred embodiment also has light source 1 on an optical axis 2 at the primary focus 3 of an ellipsoidal reflector 4. Reflector 4 focuses most of the IR, the UV and visible light emitted by the light source to conjugate focus 5 on optical axis 2. A dichroic hot mirror 6 and the proximal end of heat-conducting glass rod are placed within hole 11 in confocal reflector 10. Dichroic hot mirror 6 and heat-conducting glass rod 7 absorb UV and IR and conduct IR to cooling fins 15, while transmitting visible light to light guide 12. In this embodiment ellipsoidal reflector 4 is integral with a heat radiating cooling fins 16 and confocal reflector 10 is integral with cooling fins 19. Additionally a lamp socket 18 is in thermal contact with radiators 16, extending lamp life by cooling the glass/metal junctions of the lamp pins. Again, as in FIGS. 2 and 4, glass rod 7 receives, homogenizes and transmits the visible light to the light guide 12 at the distal end 9 of glass rod 7. Thus the light received by the fibers of light guide 12 is both cool and perfectly uniform, whereby all fibers are cool and equally bright.

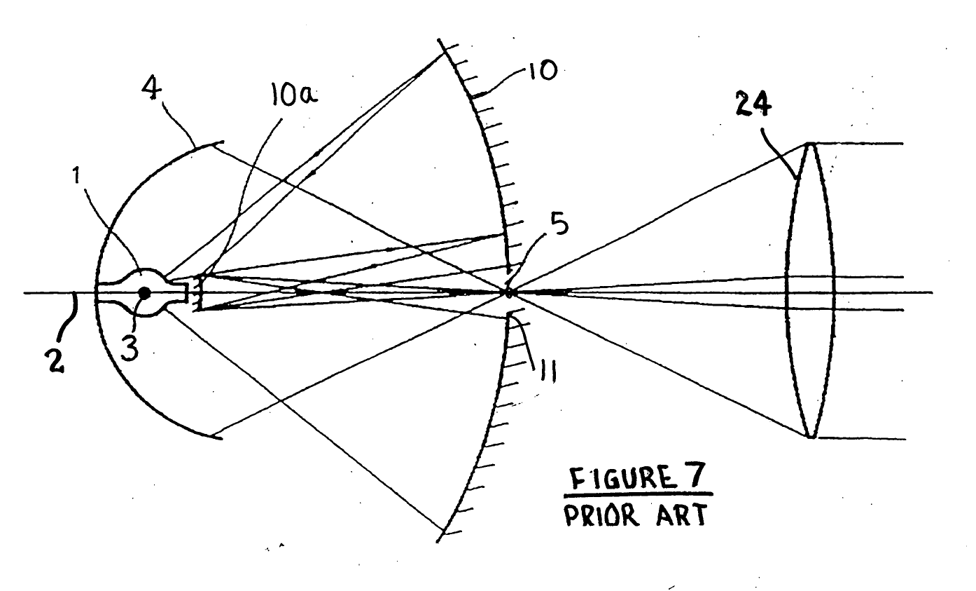

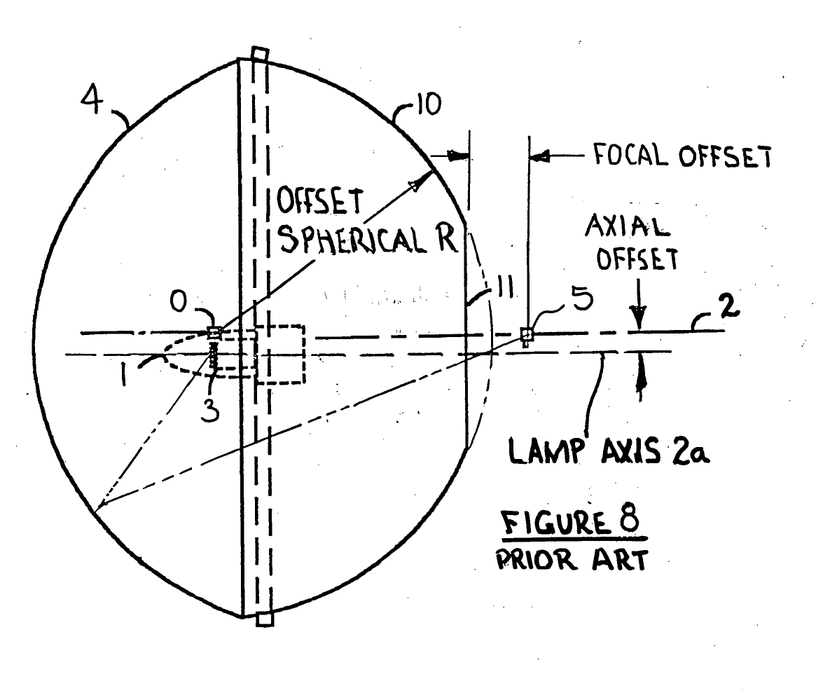

FIG. 6 is a longitudinal cross-section showing a third preferred embodiment of the present invention in which inlet air 18 moves through inlet air passages 19 for heated exit air 20 to cool glass rod 7. One or more outlet passages 22 are provided primarily to cool glass rod 8, and one or more inlet passages 21 and exit passages 23 for heated exit air 20 are provided in housing 13 to cool lamp 1, confocal mirror 10 and dichroic hot mirror 6. Although not shown, it would be obvious to anyone skilled in the art to increase the air flow with a fan.

### PRIOR ART USING SPHERICAL REFLECTORS

Prior art FIG. 7 is a longitudinal cross-section view of a prior art light projector (not a fiber optic projector) of U.S. Pat. No. 5,695,277. For clarity the applicants have again used element numbers matching those of the preferred embodiments. This patent therefore includes a lamp 1 having a light source 3 at the principal focus of an ellipsoidal reflector 4, focussing light to conjugate focus 5. This '277 patent also includes a reflector 10 that at first glance appears to be confocal with the light source. However, reflector 10 is not confocal with light source 3, in that the reflected rays from spherical reflector 10 do not return to the light source, but instead impinge a male, spherical, third reflector 10a. Focussed rays from ellipsoidal reflector 4 reflect light through conjugate focus 5 in a hole 11 in reflector 10 to a collimating lens 24, not a fiber optic light guide. Direct rays from light souce 3 are reflected back by spherical reflector 10 to reflector 10a, which is an male spherical curved reflector receiving light from reflector 4 and relaying the light to conjugate focus 5. Conjugate focus 5 in hole 11 is also the focal point of a collimating lens 24. Since the double-ended lamp 1 shown has a light-obscuring distal end connector, some light must be provided there in order to produce a beam without a lamp-end shadow, a dark spot in the projected beam. This optical system thus uses the secondary reflector 10a as a means to fill in the dark lamp-end and homogenize the light so collimating lens 24 can produce a smoother, more uniform beam.

Prior art FIG. 8 is a longitudinal cross-section view of a prior art light projector (also not a fiber optic projector) of the Bishop U.S. Pat. No. 6,161,946. One problem the '946 patent addresses is the “intensity varying radially, such that a concentric ring pattern is projected”. ('946, col 2, lines 24-26). Again, for clarity the applicants have used element numbers matching the preferred embodiments. This patent therefore includes a lamp 1 having a light source 3 at the principal focus of an ellipsoidal reflector 4, focussing light to a conjugate focus 5. This '946 patent also includes a spherical reflector 10 (like the foregoing '277 patent) that at first glance appears to be confocal with the light source. However, reflector 10 is not confocal with light source 3, because the light source 1 is laterally displaced from the optical axis of the reflectors, so reflected rays do not return to the light source, but instead impinge the principal focus of reflectors 4 and 10, substantially missing the offset axis of the light source 1. FIG. 7 in the '946 patent, clearly shows that the lamp is not on the same axis as the reflectors. This is also described in '277 claim 1, stating: . . . “a lamp inserted into said socket, said lamp comprising a cylindrical bulb and a helical filament, wherein said socket and said lamp are positioned in said slightly offset rectangular opening . . . ”. Focussed rays from ellipsoidal reflector 4 reflect light through conjugate focus 5, in a hole 11 in reflector 10 as a means to fill in the dark lamp-end to homogenize the light into a smoother, more uniform beam. This prior art light projector of the '946 patent, like the Kim '277 patent, also has no means for removal of UV or IR, and is totally unsuitable for use as a fiber optic projector.

### SUMMARY OF THE SPECIFICATION AND DRAWINGS

The primary purpose of the present invention is to provide a significant increase in optical efficiency as a major improvement over the applicants' U.S. Pat. No. 5,099,399. This is achieved by adding a spherical mirror on an optical axis and confocal with a light source at the primary focus of an ellipsoidal reflector, in which the spherical surface is and is tangent with the plane of the conjugate focus of the ellipsoidal reflector. The conjugate focus is in a central hole through the confocal reflector, whereby a substantial amount of the lost light in the '399 patent configuration is reflected back to the primary focus by the confocal mirror and re-reflected by the ellipsoidal reflector, capturing and utilizing otherwise wasted light.

No prior art patents were found that anticipate a confocal mirror reflecting light to the primary focus of an ellipsoidal reflector. Two patents were the closest prior art employing spherical reflectors. The Kim '277 prior art patent uses a small secondary reflector at the light source to make the light more uniform. The Bishop '946 prior art patent smoothes the beam by offsetting the axis of the spherical reflector with respect to the optical axis of the light source and ellipsoidal reflector. Thus neither patent has a spherical reflector that is confocal with the light source. Further, neither uses a true homogenizer such as the glass rod in the applicants' '399 patent and the present invention. Both of the foregoing prior art patents are for framing projector spotlights, not fiber optic projectors. Therefore neither patent has any means for controlling or eliminating UV or IR content from the light.

1. A fiber optic system including:
a light source including infrared and ultraviolet radiation on an optical axis, energized from a remote source of electrical power;
an ellipsoidal reflector coaxial with the optical axis, having a primary focus at the light source at the proximal end of the optical axis and a conjugate focus at an image plane spaced in the distal direction on the optical axis;
a spherical confocal reflector coaxial with the optical axis, having a confocal radius of curvature about the light source, said radius having a length equal to the distance from the primary focus to the conjugate focus;
a hole through the confocal mirror at the conjugate focus;
an elongated, transparent glass rod coaxial with the optical axis, receiving light and heat at its proximal end from light passing through the conjugate focus and the hole in the confocal reflector;
a housing enclosing said light source, ellipsoidal reflector, confocal reflector and at least a portion of the glass rod, said housing having an exit aperture at the distal end of the optical axis;
an elongated light guide comprising one or more optical fibers, having a proximal end receiving light from the distal end of the glass rod and one or more remote light-emitting ends; and
a heat flow path transferring heat from the glass rod to the exterior of the housing.

2. A fiber optic system according to claim 1 in which the ellipsoidal reflector the spherical confocal reflector and the glass rod are provided with one or more heat flow paths transferring heat to the exterior of the housing.

3. A fiber optic system according to claim 1 in which the ellipsoidal reflector and the spherical confocal reflector are integral with the housing.

4. A fiber optic system according to claim 1 in which the ellipsoidal reflector and the spherical confocal reflector are integral with the housing and said housing is provided with external heat radiating fins.

5. A fiber optic system according to claim 1 in which the ellipsoidal reflector and the spherical confocal reflector are integral with the housing, the glass rod is in thernal contact with the housing and said housing is provided with external heat radiating fins.

6. A fiber optic system according to claim 1 including one or more cooling air inlet passages along the length of the glass rod and into the housing, and one or more outlet air passages conducting air from said inlet passages out of the housing.

7. A fiber optic system according to claim 1 including one or more cooling air inlet passages in the housing adjacent to the lamp and one or more outlet air passages circulating lamp-heated air out of the housing.

8. A fiber optic system according to claim 1 including one or more cooling air inlet passages along the length of the glass rod and into the housing, one or more cooling air inlet passages in the housing adjacent to the lamp, and one or more outlet air passages to circulate heated out of the housing, optionally including a fan to increase the flow of cooling air.
